(19) United States
(12) Patent Application Publication
(10) Pub. No.: US 2002/0138336 A1
(43) Pub. Date: Sep. 26, 2002

(54) Method and system for optimizing product inventory levels

(76) Inventors: Frank Heinrich Bakes, Cincinnati, OH (US); Jonathan George Beers, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 09/820,504

(22) Filed: Mar. 29, 2001

Related U.S. Application Data
(60) Provisional application No. 60/266,613, filed on Feb. 6, 2001.

(51) Int. Cl. G06F 17/60

(52) U.S. Cl. 705/10

(57) ABSTRACT

A method and system for inventory control. According to one exemplary embodiment, inventory data relating to product inventory is collected over a period of time for a plurality of products. A statistical measure is calculated for each product from the inventory collected. The statistical measures are displayed in graphical format, such as via a Pareto chart for example, and in an ordered arrangement, such as to indicate a priority. A product can then be selected for investigation and a historical chart for the selected product can be displayed, such as via a control chart for example. Irregularities in the data can then be identified, as can the causes thereof, and inventory problems can be addressed to improve the system. In another exemplary embodiment, customers are given incentives to report out-of-stock conditions for any product, including non-promotional products, by providing compensation for such reports. The reports can be electronically recorded, analyzed, summarized, and/or utilized for identifying inventory issues.

### RELATED APPLICATION

This application claims the benefit of U.S. Provisional Application No. 60/266,613, filed Feb. 6, 2001, the entire disclosure of which is hereby incorporated herein by reference.

### COPYRIGHTS PRESERVED

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to a method and system for optimizing inventory levels, and more specifically, in one exemplary embodiment, to a method and system for identifying and resolving inventory issues by using graphical charts illustrating statistical priority and/or historical performance for inventory.

### BACKGROUND OF THE INVENTION

Optimizing inventory levels of products is often a goal for companies, such as manufacturers, suppliers, warehousers, distributers, and retailers. Inventory refers to the accumulation of products (e.g., goods, parts, resources, etc.) to meet anticipated demand for these products. Storing too much of a product than what is needed to meet demand can be inefficient and expensive. Valuable storage space is needlessly used, and the risk of damage to or deterioration of the product is increased. On the other hand, storing too little of a product than what is needed to meet demand is also not desired. When a product goes out-of-stock, potential sales are lost and disappointed customers may decide to permanently take their business to other competing companies. Often, this lost opportunity can be a major cause of market share erosion.

A number of algorithms, methods, software programs, and computer systems have been developed in various attempts to optimize inventory levels. These systems and methods generally attempt to fit the inventory performance to one or more equations or algorithms, which then can be used to forecast demand and manage inventory by controlling parameters, such as replenishment quantity, ordering frequency, ordering points, and delivery/stocking schedules. Such systems and methods may utilize data such as demand history, inventory carrying cost, and lead time to calculate or estimate the various parameters relating to inventory control.

However, despite the development and use of such conventional systems and methods, unsolved logistical problems, such as those inherent in planning, ordering, delivering and stocking products, have still resulted in higher than necessary inventory levels and continued out-of-stock situations. These conventional systems and methods for inventory replenishment have not led to the resolution of all logistical problems, especially at the retailer level where frequent human intervention is required. In particular, such systems and methods typically attempt to compensate for inventory problems by blindly adjusting control parameters, rather than identifying and resolving problems at the points where they occur. For example, the accuracy of inventory data is often dependent on the proper handling of sales transactions, returns, damaged goods, theft, and shelf stocking, as well as accurate stock counts, promotion estimates and demand estimation factors, which are typically assumed to be accurate in conventional forecasting methods. In addition, conventional forecasting methods typically rely only on current or recent data to make adjustments to control parameters, and they fail to utilize historical data and human review of such historical data, often resulting in poor results.

In addition, such systems and methods often require a detailed knowledge of statistical methods and forecasting in order to be used for their intended purposes. However retailer personnel without such knowledge often are not able of fully utilizing such systems and methods to adjust the inventory system design and control parameters. Moreover, such personnel may have difficulty using such complex systems and methods to recognize the events and factors which may contribute to inventory irregularities. Accordingly, such methods and system can fail in providing adequate feedback to the retail personnel involved in forecasting sales and ordering products for stocking shelves.

Accordingly, methods and systems are desired which can be utilized to assist in accurately identifying and resolving inventory control problems and issues, and in making any appropriate adjustment to inventory management systems and procedures, so as to better maintain optimum inventory levels. In addition, methods and systems for identifying inventory control problems are desired which do not require in depth knowledge of statistical methods, and which can be utilized by a variety of personnel, such as retail store personnel for example. Moreover, such inventory systems and methods are desired which can provide adequate inventory and/or sales feedback to retail personnel.

Conventional “raincheck” systems have been utilized to alert store personnel when an item is out-of-stock and to identify an out-of-stock situation. However, the use of such rainchecks has been limited to sale, advertised, or promotional items only, and there has been no incentive for customers to report out-of-stock situations for other products. Moreover, the cause of the out-of-stock situation has not usually been investigated, and such raincheck data has not been collected and organized for use in identifying inventory control problems and trends. Accordingly, systems and methods are desired which allow out-of-stock reporting to be utilized for a wide range of products and which allow such reporting to be utilized in identifying inventory control problems, causes, and/or trends.

### SUMMARY OF THE INVENTION

It is an object of at least one exemplary embodiment of the present invention to obviate the above-described problems.

Another object of at least one exemplary embodiment of the present invention is to optimize inventory levels and minimize overstock and out-of-stock situations.

Yet another object of at least one exemplary embodiment of the present invention is to assist in identifying and solving inventory control problems.

It is an object of at least one exemplary embodiment of the present invention to assist in identifying causes of inventory control problems to allow for appropriate adjustment of existing inventory management systems and procedures.

Another object of at least one exemplary embodiment of the present invention is to provide adequate feedback to personnel involved in sales forecasting and/or inventory control.

A further object of at least one embodiment of the present invention is to allow for improvement in existing inventory management systems, software, and/or procedures, and/or in the parameters and estimates upon which they are based.

A further object of at least one exemplary embodiment of the present invention is to provide an inventory control method and system which does not require extensive knowledge of statistics.

Another object of at least one exemplary embodiment of the present invention is to provide a system and method which increases the frequency of out-of-stock reporting.

Yet another object of at least one exemplary embodiment of the present invention is to provide a system and method which utilizes out-of-stock reporting to identify inventory control problems and trends.

Another object of at least one embodiment of the present invention is to improve product sales.

Yet another object of at least one embodiment of the present invention is to improve customer satisfaction.

The above objects are provided merely as examples, and are not limiting nor do they define the present invention or necessarily apply to every aspect thereof. Additional objects, advantages and other novel features of the invention will be set forth in part in the description that follows and will also become apparent to those skilled in the art upon consideration of the teachings of the invention.

To achieve the foregoing and other objectives, in one exemplary embodiment, a method is provided for improving product inventory levels, by reducing inventory levels while at the same minimizing out-of-stock situations. The method comprises collecting historical inventory data related to product inventory for each of a plurality of products over a period of time, such as by recording inventory levels or sales data for products on a daily basis for example. At least one statistical measure for each product is calculated from the inventory data for that product. The measure can include average, statistical rule violation, standard deviation, capability, and/or other statistics, for example. The statistical measures for the products are displayed in an ordered arrangement according to magnitude, such as in a graphical priority chart, such as a Pareto chart for example. A product is selected to investigate based upon the ordered arrangement, and at least one chart is displayed from the historical data for the selected product. The chart illustrates historical performance relating to the inventory data for the selected product over a period of time, and can comprise control charts and/or histograms for example. Based upon the chart, irregularity (e.g., cycles and trends, erratic movement) in the historical performance is identified and used to address inventory issues regarding the selected product. These charts may identify various issues that should be investigated locally to determine the cause of any problems. Based on the cause identified, the correct solution can be applied. At least portions of this exemplary method can be implemented with software or firmware and executed by a processor on a computer having a display, such as a handheld, portable computer for example.

In another exemplary embodiment, a method of receiving consumer feedback regarding out-of-stock situations is provided. The method comprises offering compensation for reporting out-of-stock situations, receiving reports of out-of-stock situations, and conveying compensation for each report received. According to another exemplary embodiment, a method of identifying inventory control issues is provided. The method comprises receiving reports of out-of-stock situations for a variety of products, including non-promotional products; electronically recording information regarding the reports received; displaying a summary of the electronic information; and using the summary to identify potential inventory issues.

Still other objects and aspects of the present invention will become apparent to those skilled in this art from the following description wherein there is shown and described exemplary embodiments of this invention, including a best mode currently contemplated for carrying out the invention, simply for the purposes of illustration. As will be realized, the invention is capable of other different aspects and embodiments without departing from the scope of the invention. Accordingly, the drawings and descriptions are to be regarded as illustrative in nature and not limiting in nature.

### BRIEF DESCRIPTION OF THE DRAWINGS

While the specification concludes with claims particularly pointing out and distinctly claiming the subject matter which is regarded as the present invention, it is believed that the exemplary embodiments of the invention will be better understood from the following descriptions which are taken in conjunction with the accompanying drawings in which like designations are used to designate substantially identical elements.

FIG. 1 is a schematic diagram illustrating an exemplary system for inventory control, made according to principles of the present invention;

FIG. 2 is a flow diagram illustrating an exemplary method for optimizing inventory according to principles of the present invention;

FIG. 3 is a data table illustrating exemplary inventory data which can be collected for a variety of products and analyzed using the method illustrated in FIG. 2;

FIG. 4 illustrates an exemplary graphical priority screen, which is constructed according to principles of the present invention and which can be utilized with the system and method of FIGS. 1-2;

FIG. 5 illustrates an exemplary historical chart screen, which is constructed according to principles of the present invention and which can be utilized with the system and method of FIGS. 1-2;

FIG. 6 is a flow diagram illustrating an exemplary method for identifying and resolving inventory control problems in accordance with principles of the present invention;

FIG. 7 is a flow diagram illustrating an exemplary method for obtaining and utilizing out-of-stock reports from consumers, in accordance with principles of the present invention;

FIG. 8 is an exemplary report that can be generated by the method of FIG. 7, in accordance with principles of the present invention;

FIG. 9 is an exemplary screen illustrating exemplary statistical measures that can be calculated from inventory data according to principles of the present invention; and

FIG. 10 is a functional block diagram illustrating an exemplary combination of processes and components for use in optimizing inventory levels according to principles of the present invention.

### DETAILED DESCRIPTION OF EXEMPLARY EMBODIMENTS

In general, a method and system is provided for inventory control by the identification and resolution of inventory control issues. According to one exemplary embodiment, inventory data relating to product inventory is collected over a period of time for a plurality of products. A statistical measure is calculated for each product from the inventory collected. The statistical measures are displayed in graphical format, such as via a Pareto chart or bar chart for example, and in an ordered arrangement, such as to indicate a priority. A product can then be selected for investigation and a historical chart for the selected product can be displayed, such as via a control chart for example. Using these charts, irregularities in the data can be identified, as can the causes thereof, and inventory problems can be addressed to improve the system. In another exemplary embodiment, customers are given incentives to report out-of-stock conditions for any product, including non-promotional products, by providing compensation for such reports. The reports can be electronically recorded, analyzed, summarized, and/or utilized for identifying inventory issues.

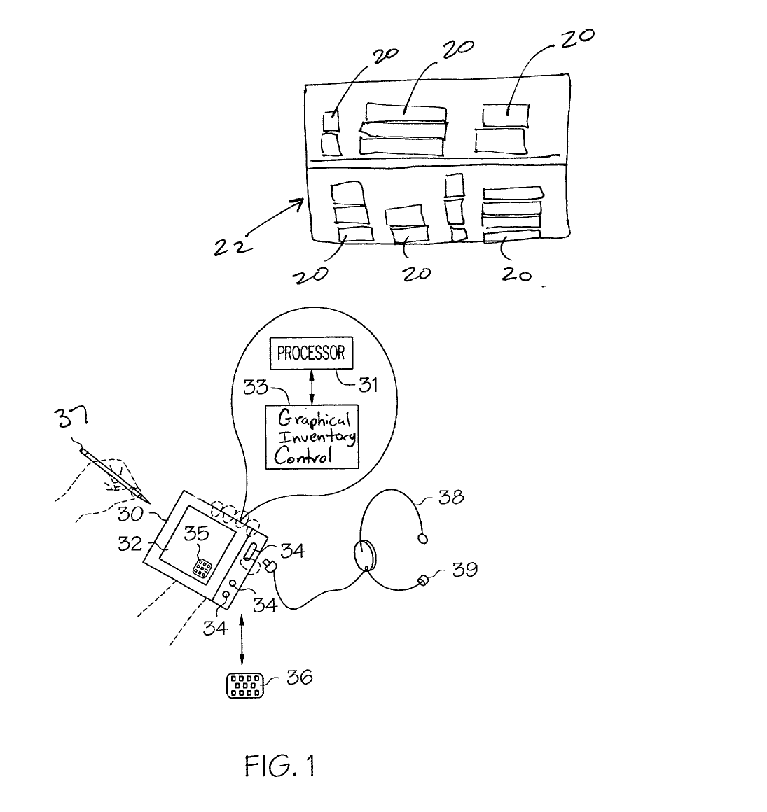

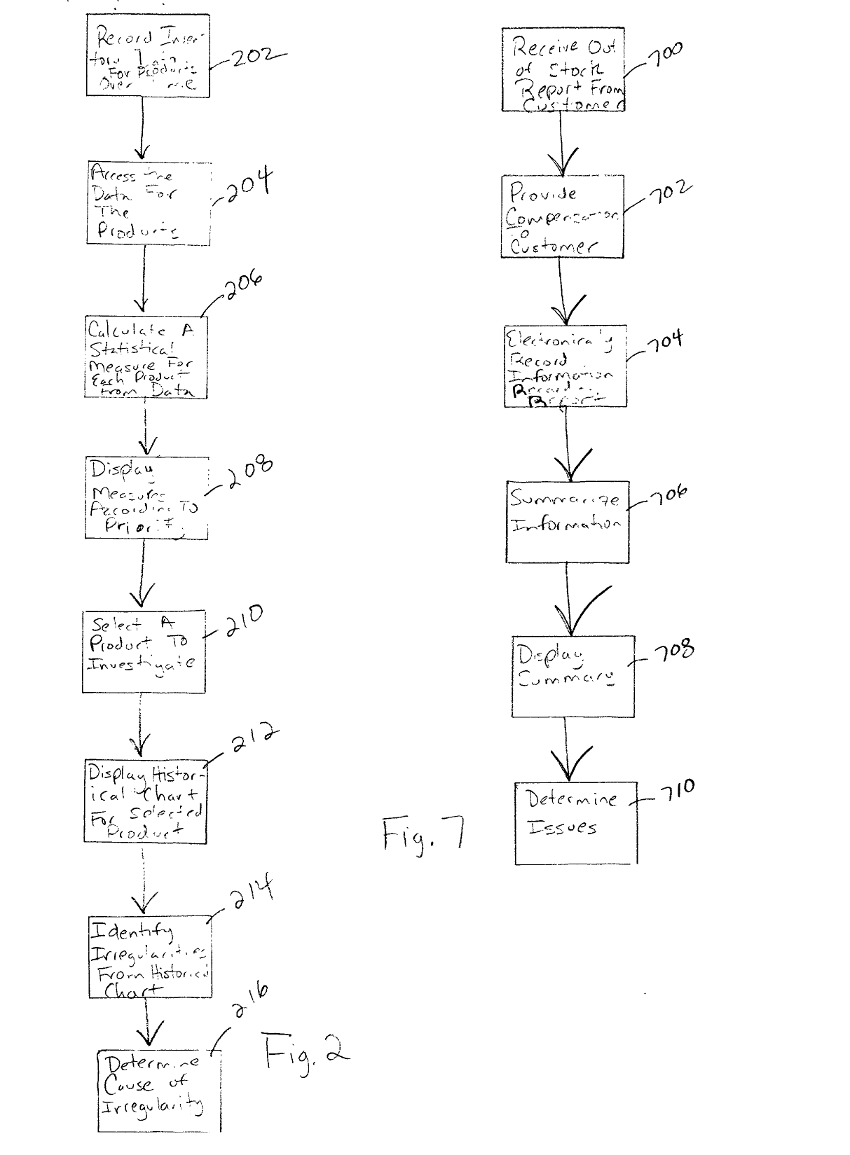

Turning now to the drawings in detail, wherein like numbers illustrate corresponding structure, FIG. 1 is an exemplary system for optimizing inventory levels comprising a portable computer and related devices, which can run software and/or firmware programs which operate according to principles of the present invention. In this exemplary embodiment, a portable computer 30 is utilized for viewing, in a prioritized ordered arrangement via a graphical chart, statistical measures calculated from historical inventory data for each a variety of products. In particular, the portable computer 30 includes a display 32 for viewing these measures. The display 32 could comprise a monitor, a liquid crystal display (LCD), a touchscreen display (which, in addition to displaying information, also allows the user to enter inputs by touching the display with a finger or with a special pen or stylus 37), and/or any other viewing screen or interface. A keyboard 36 and/or mouse also may be utilized to communicate with the computer 30, via wired or wireless channels, to provide inputs to the computer 30. A keypad 35, onscreen or hardware related, may also be provided to assist in entering data from the user. As another option, a microphone 39 can be provided for use in conjunction with voice recognition software for providing inputs to the computer 30. The microphone 39 can communicate with the computer 30 in any suitable manner, such as by plugging into a port 34 on the computer.

The portable computer 30 may comprise a general purpose or special purpose computer including a processor 31, such as a microprocessor or control circuit for example, and a non-volatile memory device 33 for storing programs having instructions. For instance, the memory device 33 may comprise a hard disk drive, a CD ROM drive, a floppy disk drive, a flash memory unit, and/or a ROM chip. The computer 30 may also include volatile memory, such as RAM or DRAM chips for instance, for use in executing programmed instructions, as well as appropriate circuitry for interfacing with the volatile and nonvolatile memory. Communication ports 34 and/or related circuitry may also be provided to interface the computer 30 with various devices, including input/output devices, such as keyboards, microphones, and printers for instance, as well as to interface with other computer devices via wired or wireless network or modem communications.

The portable computer 30 can include a self-contained power source such as an onboard battery to allow the unit to be comfortably carried by a user (e.g., a store employee) for extended periods of time. For example, the person utilizing the computer may use it while walking through a retail store and viewing charts (e.g., graphs, plots, curves, etc.) illustrating statistical measures and/or historical performance regarding inventory of various products 20, as the product shelves 22 are being viewed. The products can include supplies, materials, consumer items, articles of manufacture, and commercial items, for example.

In one exemplary embodiment, the computer 30 comprises a tablet computer or pen computer, such as, for instance, the STYLISTIC or PENCENTRA models offered by Fujitsu Personal Systems, Inc. Such computers offer processing power, light weight, and long battery life. However, it should be understood that any of a variety of computers could be utilized with the methods and programs of the present invention, and the computers described herein may include laptop computers, notebook computers, desktop computers, portable data collectors, input stations, personal digital assistants (PDA's), portable electronic devices, Internet appliances, or other data input and/or display devices. The computer 30 may allow the user to easily view statistical measures and/or historical performance regarding product inventory and, as will be understood, can take any of a virtually unlimited number of alternative forms. Standard operating system software can be utilized with the computer 30, if desired, such as WINDOWS operating system software for instance. A graphical inventory control software or firmware program, such as one operating according to the exemplary method described in further detail below, can be stored in memory 33 and run on the computer 30.

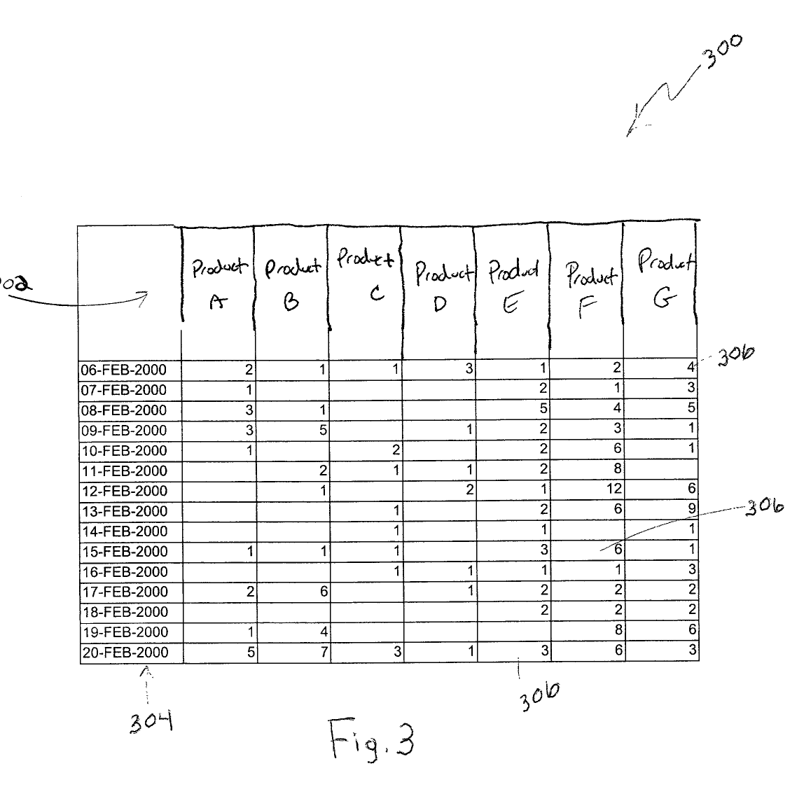

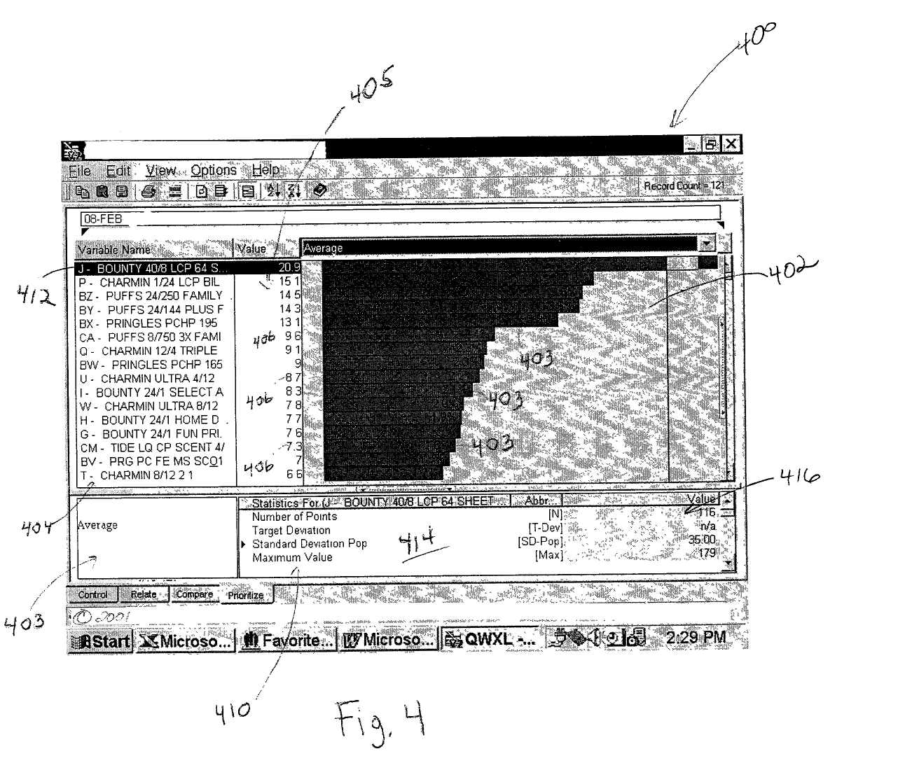

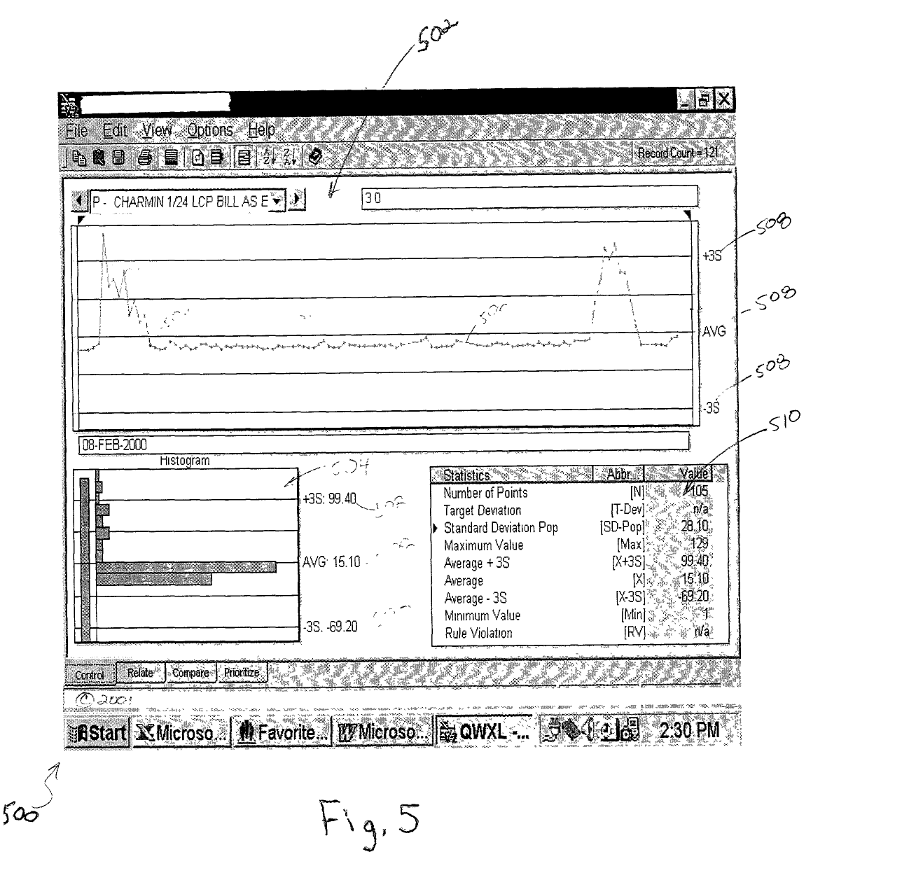

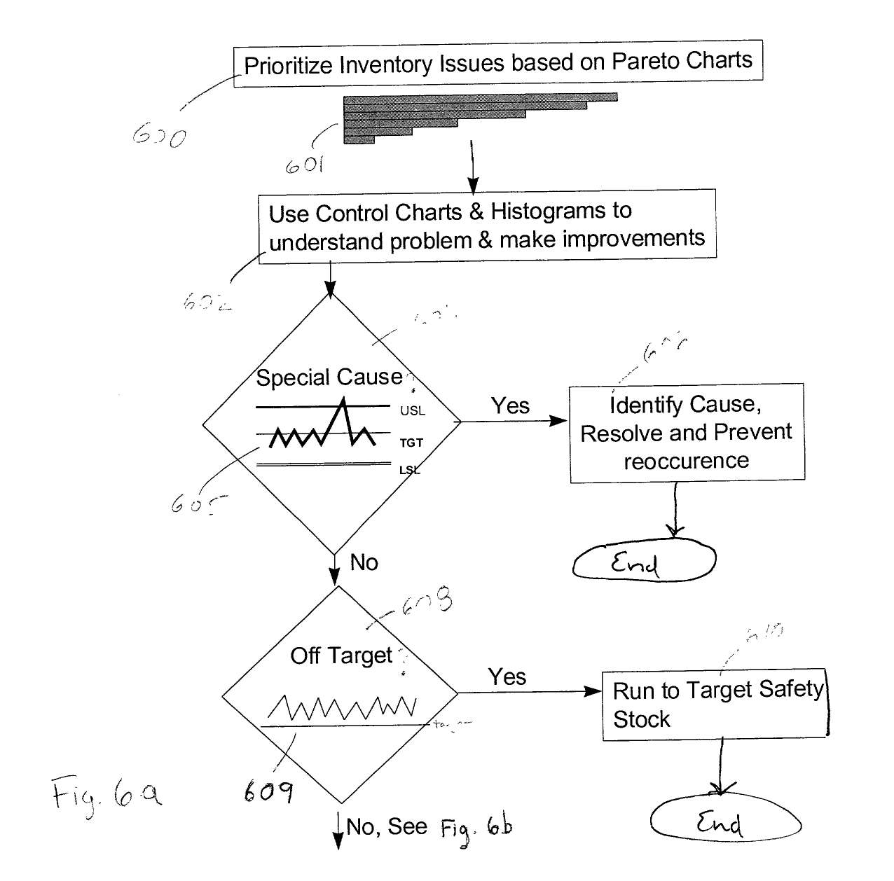

FIG. 2 is a flow diagram illustrating an exemplary method according to which such software or firmware associated with the computer may operate. In addition, FIG. 3 illustrates exemplary inventory data which may be utilized by such a software or firmware program, and FIGS. 4-5 illustrate graphical user interfaces, such as computer screen images for instance, which can utilize windows, frames, pages, icons, toolbars, menus, and/or text, in order to display and organize statistical measures and/or historical performance of inventory data of products.

More specifically, the user can begin an assessment by executing the stored software program, such as by selecting the appropriate program from a list or from a group of icons using an input device, or otherwise providing a predetermined input to begin execution of the program. The program may be written in any of a variety of languages suitable for creating software or firmware programs. For instance, languages such as C++, HTML, and/or Visual Basic may be utilized.

As shown at block 202 of FIG. 2, inventory data relating to product inventory for a variety of products is collected over a period of time. Such inventory data can include any number of inventory measures including, but not limited to, product sales levels, product inventory levels, cost of inventory, product replenishment frequency, product replenishment quantity, and product replenishment timing (e.g, dates and times). The inventory data of interest is collected on a periodic basis over a period of time, such as, for instance, daily, hourly, weekly, monthly, and/or yearly. For example, sales levels or inventory levels could be collected on a daily basis over a period of one or more months, such as a period of 100 or more days, a period of three or more months, or a period of twelve or more months . This inventory data can be collected in a variety of suitable manners. With regard to sales levels and product inventory levels, as known in the art of retail sales, data can be collected automatically by electronically keeping track of sales and adjusting a running tally of these levels via a software program. Purchases of items can be recorded electronically, such as via barcode readers, and a sales level and/or inventory level for the product purchased can be adjusted based upon the sale. With regard to product replenishment frequency, quantity and timing, such data can be recorded whenever product supplies are replenished.

FIG. 3 provides an exemplary illustration of such inventory data. In this example, a data table 300 is provided for displaying daily product sales levels for a variety of products, collected over a period of 15 days. Row 302 lists the products for which the data was collected, and column 304 lists the days for which the data was collected. The entries 306 list the number of products sold for the corresponding product on the corresponding day.

The inventory data can be stored in any suitable manner. For example, data storage media, such as electronic storage media and the like, can be utilized to store the data. Moreover, the data may be held in any suitable manner, arrangement, and format, such as in databases, spreadsheets, data tables, or data stores for example.

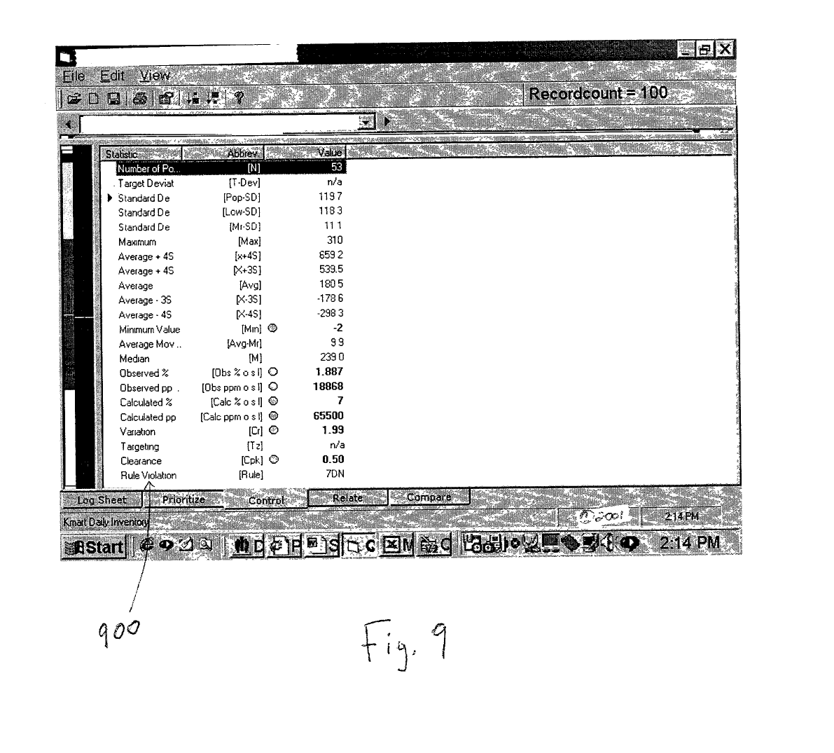

Turning again to FIG. 2, at block 204, the stored inventory data for the products is accessed. This can be achieved, for example, by addressing the data storage files or memory locations, importing the data, retrieving or receiving the data, or the like. Once the collected data is accessed, one or more statistical measures can be calculated for each product from the historical inventory data for that product, as shown at block 206 of FIG. 2. The statistical measures can include any desirable value, parameter, level, statistic, term, calculation, variable and the like. For example, these statistical measures can include average value, minimum value, maximum value, standard deviation, target deviation, average plus or minus a number of standard deviations, variation, capability clearance, percentage out-of-stock, control values, and target Z, as shown in the exemplary list 900 of statistical measures provided in FIG. 9.

Any number of suitable equations or calculations can be utilized to determine the statistical measure, and the equation or calculation chosen will depend on the measures which are utilized. Exemplary equations are disclosed in Understanding Statistical Process Control, Second Edition, by Donald J. Wheeler and David S. Chalmers, SPC Press, 1992, the entire disclosure of which is hereby incorporated herein by reference.

Exemplary equations for some statistical measures which could be utilized will now be described. For instance, the mathematical average of the inventory can be calculated by:

$$\overline{X} = \frac{X1 + X2 + ⋯ Xn}{n}$$

$$where n = number$$

of data points in the time period for the product

As another example, capability clearance, represented by Cpk, utilizes two separate calculations, with the smaller of the two results being selected:

$$\frac{USL - \overline{X}}{3 S}$$

$$AND$$

$$\frac{\overline{X} - LSL}{3 S}$$

where USL is the upper specification limit, LSL is the lower specification limit and S is the standard deviation. If the inventory data comprises product inventory levels, the upper and lower specification limits can be determined by research or experience regarding maximum and minimum inventory levels for the product. Based upon the research or experience, the limits are set at levels within which the inventory levels are thought to be in control. Exceeding these limits indicates a high probability that an inventory control problem exists and needs to be corrected.

Moreover, target deviation can be calculated by the following equation:

Δ(\overline{X},T)=\overline{X}−Tgt

where Tgt=the target

value for the variable.

Likewise, target deviation can be calculated by the expression

$$Tz = \frac{\overline{X} - Tgt}{S}$$

It should be understood that these statistical measures are only utilized as examples and that other statistical measures can also be calculated as desired. In the exemplary method of FIG. 2, one or more of these measures are calculated for each product based upon the historical inventory data collected. For example, with reference to FIG. 3, the data in the column for Product A would be utilized to calculate a value for the statistical measure for Product A, the data in the column for Product B would be utilized to calculate a value for that statistical measure for Product B, etc.

Returning again to FIG. 2, once a value is calculated for the statistical measure for each of the products of interest, the process continues to block 208. At this step, the values for the statistical measure are displayed in an ordered arrangement, such as in a hierarchical arrangement, increasing value arrangement, decreasing value arrangement, or priority arrangement, for example. A graphical priority chart can be utilized to display the measures in this ordered arrangement. For example, as shown in the exemplary graphical priority screen of FIG. 4, a Pareto chart 402 could be utilized. In this exemplary screen 400, the products 404 are ordered from highest to lowest based upon the values 406 of the statistical measure 408 of interest. The Pareto chart 402 displays these values with bars of varying length according to the corresponding value 406 of the corresponding product 404. According, by the ordered arrangement of the values 406 in the value section 405 of the screen 400, as well as by the ordered arrangement of the bars 403 in the chart 402, the user is able to quickly determine which products 404 have extreme values for the statistical measure 408 being viewed. Accordingly, the products which should have priority with respect to that measure 408 are easily determined. As also seen in FIG. 4, a product may be selected, such as by selecting on the product name with an input device. In response to the selection, other statistical measures 410 for the selected product 412 will then be displayed in the detail section 414, as well as the values 416 for the corresponding measures 410. These values 416 are calculated from the historical inventory data collected for that selected product 412 over the desired period of time.

Returning again to FIG. 2, from the graphical ordered arrangement of the values for the statistical measures for the products, the user can select a product to be investigated, as shown at block 210. For example, the user may select one of the product names 404 in the screen of FIG. 4 to further investigate its historical performance with respect to the inventory data collected. For example, a product may be selected because it is deemed statistically out of control or irregular based upon the measure taken for it. In an ordered arrangement, such products would typically appear at one end of the listing. In addition or as an alternative, an alarm can be automatically displayed or otherwise indicated for those products which are not controlled based upon the value for the statistical measure.

Upon selection, a graphical historical chart is displayed for the selected product illustrating its historical performance over the desired time frame, as shown at block 212 of FIG. 2. FIG. 5 illustrates an exemplary historical charting screen 500 which can be utilized for this purpose. In this example, two graphical historical charts are utilized, one being a control chart 502 derived from the inventory data for the selected product, the other being a histogram 504 (i.e., showing possible values versus frequency of those possible values) derived from the inventory data for the selected product. Other graphical historical charts could also be utilized as alternatives or in addition to those shown. For instance, scatter plots, range charts, trend charts, comparison charts, and relationship charts could be utilized.

In the example of FIG. 5, the control chart 502 illustrates the historical performance of the inventory data. In other words, the chart 502 displays the inventory data values (i.e., the values themselves and/or values related thereto or derived therefrom) on one axis, and the time period of interest on another axis. The data values 504 are plotted over time and the values are connected with lines 506 or curves, to give the user a perspective of the change in these values over the time period. Values 508 of statistical measures for that product can also be shown on the chart 502 to indicate when certain levels are reached in the data. In this example, the average value, the positive three standard deviations value, and the negative three standard deviations value are displayed on the chart 502, as well as on the chart 504. Other values 510 of statistical measures for the selected product can also be displayed.

Returning again to FIG. 2, from the graphical historical chart, irregularities in inventory control can be identified, as shown at block 214. For example, irregularities may be identified if the chart falls below a certain statistical level and/or makes changes of particular magnitude. Additional exemplary irregularities will be identified in more detail below and can include the identification of trends, shifts, spikes, erratic movement, cycles, and the like regarding high or low inventory levels. These irregularities can then be investigated to determine their cause and to attempt to correct inventory control problems, so as to optimize inventory levels. The timing of the irregularity, the frequency of the irregularity, the number and types of irregularities, and/or the magnitude of the irregularity can be utilized in determining and resolving the inventory problem, as described in more detail below. Potential causes may be attributable to various points in the distribution network, and may be attributable to ordering, stocking, receiving, delivering, counting, tracking, forecasting, personnel, promotions, and shelf size, for example. By finding and fixing these problems, required inventory levels and costs associated therewith can be reduced, out-of-stock situations and lost sales due thereto can be reduced, and customer satisfaction can be increased.

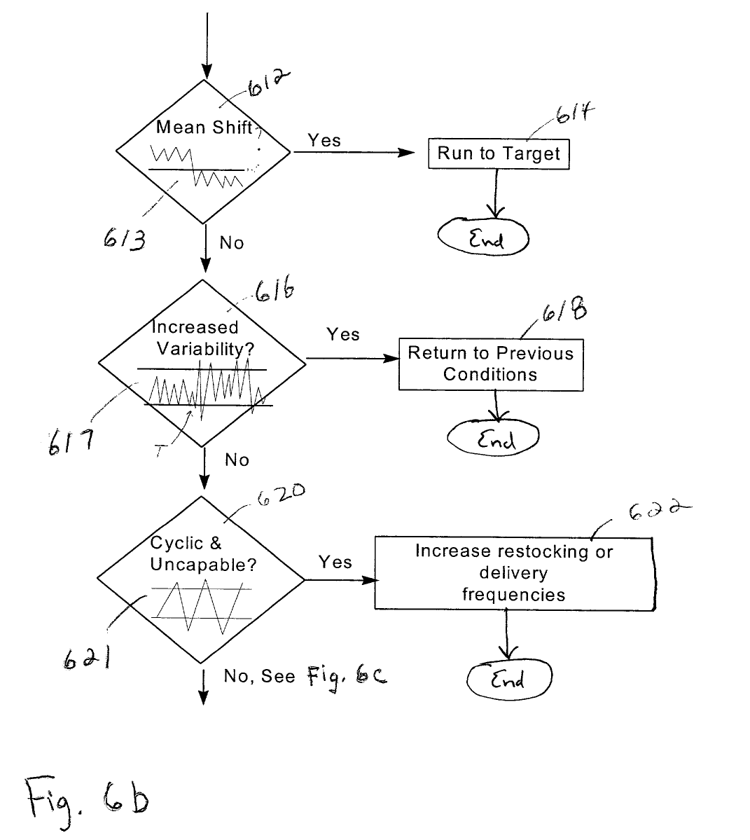

FIG. 6 illustrates an alternative exemplary method which can be utilized for optimizing inventory. In this example, at block 600, inventory issues for various products are prioritized using a Pareto chart displaying a ordered graphical arrangement of the values for the statistical measure calculated on the inventory data for the products. An example of such a chart is shown at reference numeral 601. For products which are deemed high priority, control charts and/or histograms are utilized to identify problems in inventory control for the product and to help resolve these problems, as shown at block 602.

The remaining blocks of FIG. 6 illustrate exemplary analysis steps which may be taken during the execution of block 602 to identify causes of inventory control problems. In particular, at block 604, it can be determined whether the control chart shows a one-time irregularity indicating that it is probably due to a special cause. An example of such an irregularity is shown in chart 605 where the data exceeds the USL at one point in time. If this is the case, then, as shown at block 606, the timing of that event can be utilized to identify the causes of the irregularity. For example, the facts and circumstances surrounding the stocking of that product at about the timing of the irregularity can be investigated. Upon investigation, it may be discovered, for instance, that an increase in the usual replenishment amount was ordered, accidently. Once this cause is identified, it can then be resolved to prevent reoccurrence. For example, if the cause was an accidental over-ordering of the product, reminders or alerts could be provided regarding the correct amount to be ordered.

At block 608, it can be determined whether the inventory data was continuously above or below a target level for the period of time of interest. To conduct such an analysis, a target inventory level would be determined. For example, the target level could be the average inventory level which would minimize inventory without going out-of-stock (also known as the safety stock). An example of a scenario where the inventory data is continuously above the target level is shown in the control chart 609. If such a situation is encountered, then inventory control parameters could be adjusted to better meet the target level. This step is shown at block 610. For instance, replenishment quantity and/or frequency could be adjusted.

At block 612, it can be determined whether the historical chart shows a mean shift. An example of such a shift is shown in the chart 613. In this example, the inventory shifts from being above the statistical mean to being below the mean for the selected time period. In this case, a potential course of action would be to adjust inventory control parameters as needed to maintain the inventory levels closer to the target level, as shown at block 614.

At block 616, it can be determined whether the historical chart shows increased variability. Control chart 617 illustrates an example of increased variability. In this example, the data initially remains between two limits, but later begins to shift above and/or below these limits. In this instance, and as shown at block 618, it may be desirable to return to the inventory conditions and parameters which were utilized before the increase in variability was experienced. For example, it may be determined that at some point in time T, replenishment amount was increased but the timing between replenishment was also increased. Returning to the replenishment amount and frequency may alleviate the problem.

Turning now to block 620, it is determined whether the inventory data is cyclic and uncapable. Exemplary control chart 621 shows a situation where the data seems to follow a periodic curve and the peaks of the curve consistently and periodically fall below the upper limit and below the lower limit (e.g., control limits). If this is the situation, restocking or delivery frequencies may be the problem. Accordingly, as shown at block 622, it may be desirable to increase the restocking and delivery frequencies, to maintain the data between the limits.

At block 624, it can be determined whether the control chart shows incapability and whether the histogram data follows a distribution curve which is non-normal (not following a normal or bell-shaped distribution curve). Such a scenario is shown by exemplary control chart 625, where the data constantly falls below a limit, and in exemplary distribution plot 627, where the frequency of the data is skewed toward low values. In this situation, as shown at block 626, it may be possible to determine the problem by identifying the cause of the non-normality of distribution plot 627. Moreover, as shown at block 626A, it may be possible to reduce the inventory based on the shape of the plot 627. In other words, based on the shape of this curve 627, one can infer problems and identify potential improvements. Such a curve can help to show where most of the data points are falling, in contrast to an average which can sometimes be skewed by a few data points falling at extremes. Accordingly, if many of the data points falls below or above a certain limit or level, a particular adjustment of inventory control parameters may be appropriate. Exemplary distribution shapes include exponential, Poisson, normal, and bi-modal.

A final exemplary scenario which may be encountered and used to identify a potential inventory problem is shown at block 628. Here, the control chart is controlled but uncapable and the distribution curve is normal. An example of such a control chart is shown at plot 629 and an example of a normal or Gaussian distribution is shown at plot 631. In this scenario, it may be desirable to improve the design of the inventory system, rather than the control of the system, as shown at block 630. In particular, improvements in the fundamental operation and tools of the system may be needed rather than improvements in the parameters used to control the existing system. For example, it may be desirable to redesign facilities, forecasting software, workprocesses, shelving, delivery frequency, number of employees, number of product promotions, etc. Another potential course of action in response to such a scenario is shown at block 632. As shown at this block, it also may be prudent to increase the inventory target level.

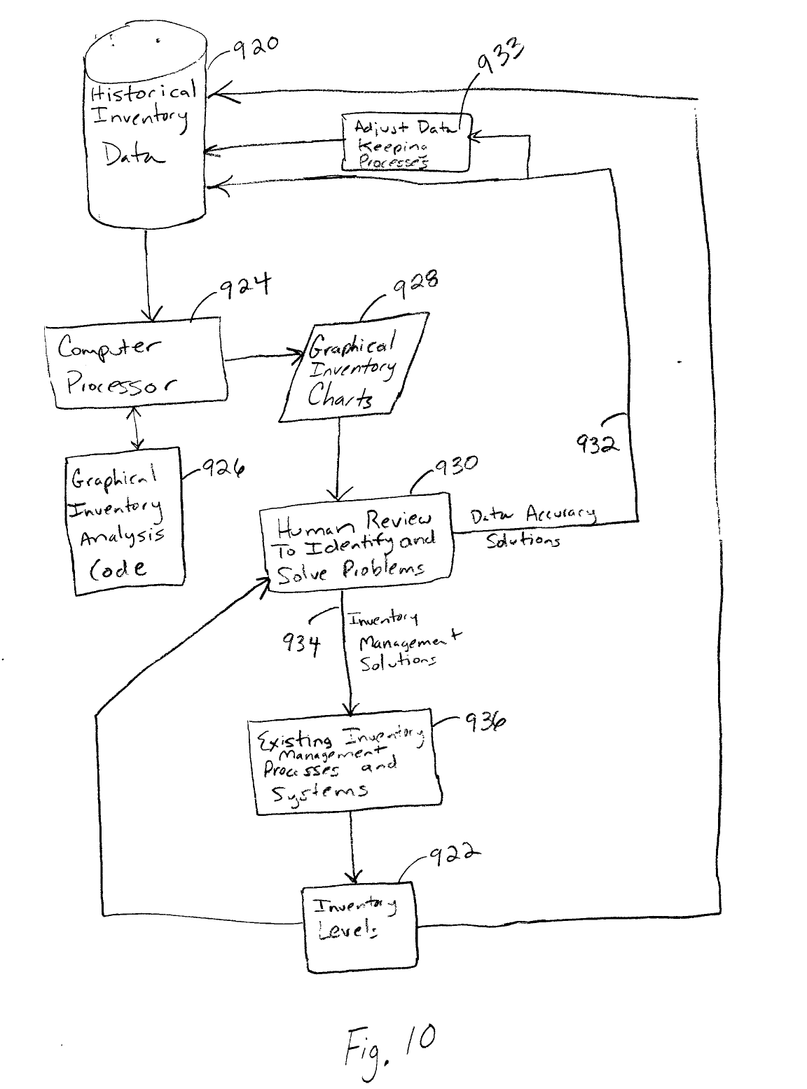

FIG. 10 is a functional block diagram illustrating another exemplary interconnection of processes and components for use in optimizing inventory levels in accordance with principles of the present invention. In this example, historical inventory data is saved in a data recording medium 920 by periodically recording data related to inventory levels 922 over a period of time. A computer processor 924 retrieves the data from the medium 920 and utilizes graphical inventory analysis code 926 to produce graphical inventory charts 928, such as priority charts (e.g., Pareto charts) and/or control charts for example. As shown at block 930, the human user reviews the charts 928 and actual product inventory levels 922 and identifies and solves problems regarding the inventory system. The solutions can include solving problems regarding accuracy of the inventory data, as shown by line 932. In this case, the inventory data on the medium 920 needs to be corrected or adjusted in order to better represent the inventory level conditions 922. Another possible solution can relate to adjustment of inventory management systems and processes, as shown by line 934. In this case, the procedures and systems in place for managing inventory are adjusted as needed and as determined by utilizing the charts 928. Such adjustments can include adjustments in ordering, stocking, and shelving processes and/or personnel, and/or adjustments in inventory forecasting and ordering tools and estimates, such as adjustments in any conventional forecasting software which may be in place and/or the parameters/estimates upon which such software operates.

In particular, the charts 928 may be utilized to identify various issues that should be investigated locally to determine their cause. Based upon the cause identified, the correct solution should then be applied. For example, if the charts show historical inventory data 920 which is lower than the actual inventory levels 922, then one solution 932 might be to correct the inaccuracy in the data 920 and to identify the cause of the inaccuracy. The cause could be, for example, related to a failure to reconcile returned products with the inventory data kept, in which case processes should be put in place to ensure that inventory data is adjusted when returned products are received, as shown at block 933.

As another example, if the charts 928 indicate that the inventory runs out during each promotion and during each winter weather emergency, the solution 934 could be to adjust the existing forecasting software 936 so that it is informed of such events and can then adjust the inventory requirements accordingly. As another example, if the charts 928 indicate that excessive inventory is being carried, and the actual inventory levels 922 are reviewed to indicate that the data is correct, then the solution 934 could involve adjustment of the ordering quantities utilized in the current inventory management system 936, so that less inventory is carried. As another example, the chart 928 could indicate an erratic inventory data occurrence. Rather than making an erratic adjustment to the data 920 or the systems and processes 936, the occurrence could be verified and it could be determined whether the occurrence was a one time event or whether it might be repeatable. An investigation as to the timing and the type of occurrence could lead to the identification of its cause. For example, it could be determined if the timing of the occurrence coincided with a weather event, a product promotion, a personnel strike, a missed delivery, a product manufacturing problem, etc, in order to identify the cause of the occurrence. If it is determined that the cause may be repeatable, then the processes and systems 936 can be adjusted when such a cause begins to occur or is predicted to occur again.

Accordingly, the above description, taken in conjunction with the corresponding figures, illustrates exemplary ways in which historical inventory data can be processed and presented in graphical form to identify causes of inventory problems and to take remedial action. However, it should be understood that principles of the present invention can be utilized with any of a variety of alternative graphical statistical charts to identify a variety of alternative irregularities which may require a variety of alternative remedial actions. Accordingly, many other variations are possible. The methods and systems described can be utilized to reduce inventory levels when appropriate, thereby saving money, while at the same time reducing out-of-stock situations, thereby increasing customer satisfaction and sales. Moreover, the methods and systems can be useful in optimizing shelf quantity and size.

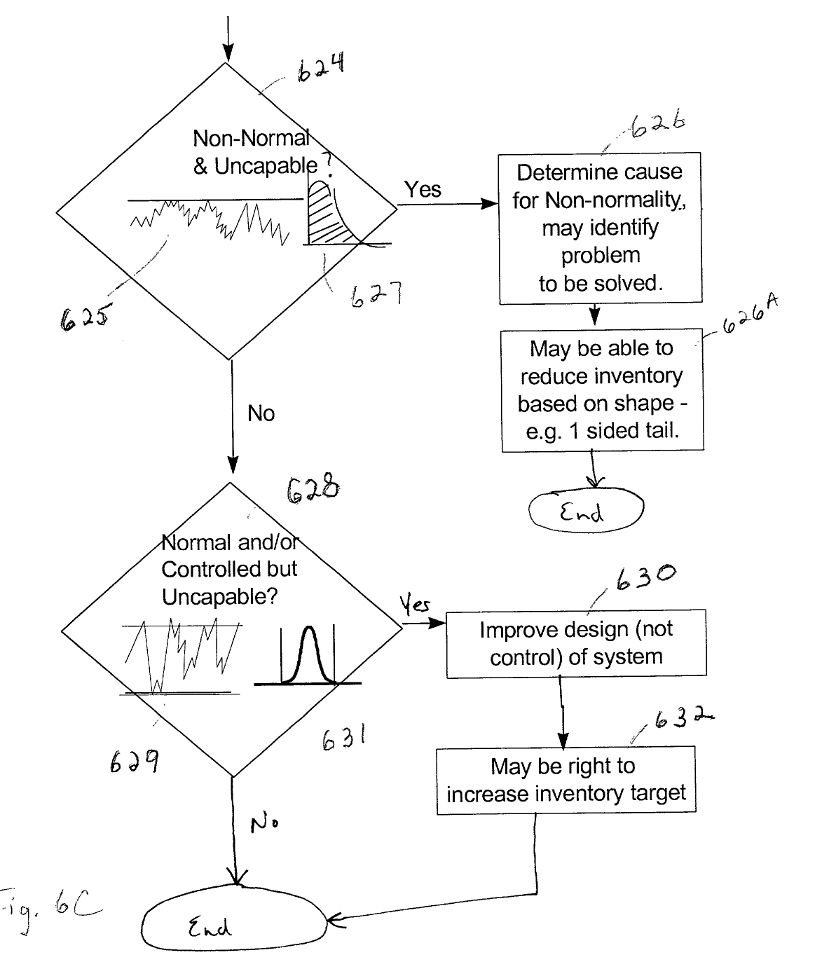

FIG. 7 illustrates an exemplary method for using customer reports of out-of-stock conditions for improving inventory control. In particular, at block 700, an out-of-stock report is received from a customer, such as in written, verbal, or electronic form for example. At block 702, the customer providing the report is given compensation in exchange for providing the report. Compensation can be in the form of one or more product discounts, coupons, gift items, or currency, for example. Providing compensation can increase the possibility that out-of-stock reports will be provided, thereby increasing the amount of feedback regarding the inventory system, as well as presenting issues and problems which can be addressed to improve the system. Such compensation could be offered for reports of out-of-stock situations on any product in the store, not just promotional items (i.e., not just sale or advertised or featured items, the type of items to which rainchecks are typically given when a customer is faced with an out-of-stock product.) The fact that the store offers compensation for any type of product could be made known to the customer through signs in the stores, announcements, advertisements, or other suitable communication methods.

At block 704, the report of the out-of-stock situation is electronically recorded, such as via a computer or other electronic storage device. The report information recorded can include a variety of information regarding the out-of-stock situation. For example, the product out-of-stock, the date and time, the customer name and contact information, whether the product was on sale or advertised, and other information can be recorded as desired The cause of the out-of-stock situation can also be determined when a report is submitted For instance, store personnel could determine whether the product was not on the shelves but was in the storage room or on a delivery truck in the parking lot, whether the product was shelved in the wrong place, or whether the product was truly not located anywhere in or near the store. The data can be stored on a data recording medium in any suitable format, such as in a database, spreadsheet, data table, or the like.

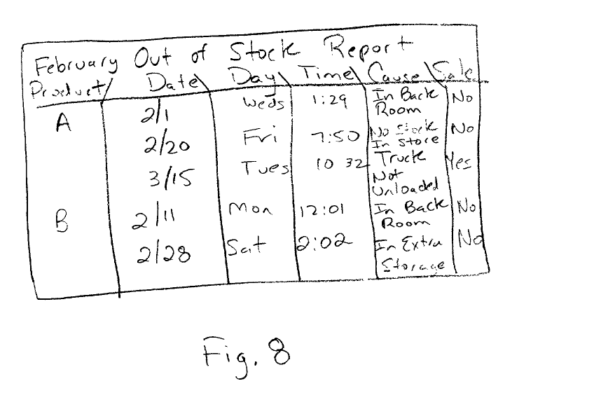

By storing the information electronically, summaries regarding the out-of-stock situations reported can be easily generated, as shown at block 706. Any suitable program for organizing data in a report format could be utilized for this purpose. The summary can then be displayed, as shown at block 708, such as on a screen or on printable medium. An exemplary summary report that could be utilized is shown in FIG. 8. In this summary, the out-of-stock reports received for the month of February are displayed and are organized according to product. For instance, reports for Product A are listed together and reports for Product B are listed together. Information regarding each out-of-stock report is also displayed. In this example, the date of each report, the day of the week of the report, the time of the report, the cause of the out-of-stock condition, and whether or not the product was on sale are listed.

By reviewing such a summary, potential inventory control problems and issues can be determined, as shown at block 710 of FIG. 7. For example, if it is determined that Product A is out-of-stock each time it goes on sale, then it may be advisable to increase the amount of product ordered before that product is scheduled to be on sale. As another example, if it is determined that Product B is out-of-stock on every Monday, but that the product is in the back room in each of these out-of-stock reports, it may be desirable to determine if there is sufficient personnel for restocking shelves on Mondays.

Accordingly, the reporting of out-of-stock conditions for a variety of products can provide feedback to help improve inventory control, resulting in fewer out-of-stock situations, more satisfied customers, and/or increased sales. Providing compensation (e.g., incentives) for the customer to report out-of-stock situations increases the chances that reports will be filed by customers, and also can improve customer satisfaction. Through the report information, customers can be contacted when the product arrives, increasing the chances that the customer will return to that store to buy the product.

Having shown and described the exemplary embodiments of the present invention, further adaptions of the methods and systems as described herein can be accomplished by appropriate modifications by one of ordinary skill in the art without departing from the scope of the present invention. Several of these potential modifications and alternatives have been mentioned, and others will be apparent to those skilled in the art. For example, while exemplary embodiments of the inventive system and process have been discussed for illustrative purposes, it should be understood that the elements described will be constantly updated and improved by technological advances. Accordingly, the scope of the present invention should be considered in terms of the following claims and is understood not to be limited to the details of structure, operation or process steps as shown and described in the specification and drawings.

What is claimed is:

1. A method for improving product inventory levels comprising:
obtaining inventory data related to product inventory for each of a plurality of products;
calculating a statistical measure for each product from the inventory data for that product;
displaying the statistical measures for the products in an ordered arrangement according to priority;
selecting a product to investigate based upon the ordered arrangement;
displaying a chart from the inventory data for the selected product, wherein the chart illustrates historical performance relating to the inventory data for the selected product over a period of time;
identifying an irregularity in the historical performance; and
using the irregularity to address inventory issues regarding the selected product.

2. The method as recited in claim 1, wherein the statistical measures are displayed in an ordered arrangement in a Pareto chart.

3. The method as recited in claim 1, wherein the historical chart comprises at least one of control chart, histogram, scatter plot, comparison chart, and relationship chart.

4. The method as recited in claim 1, wherein the inventory data comprises at least one of sales levels, inventory levels, replenishment frequency, replenishment quantity, and replenishment timing.

5. The method as recited in claim 1, wherein the statistical measure comprises at least one of average value, minimum value, maximum value, standard deviation, target deviation, percentage out-of-stock, control state, capability clearance, and target Z.

6. The method as recited in claim 1, wherein the inventory data comprises historical inventory data collected over a period of at least one month.

7. A system for identifying product inventory issues, comprising:
a processor;
a display unit in communication with the processor;
a memory in communication with the processor and adapted for storage of inventory data relating to product inventory;
a program adapted to be executed by the processor, wherein the program is configured to display a historical chart on the display unit from inventory data relating to product inventory, wherein the historical chart illustrates historical performance relating to the inventory data for the product over a period of time, and wherein the program is further configured to calculate a statistical measure for each product from the inventory data for that product and display on the display unit the statistical measures for the products in an ordered arrangement according to priority.

8. The system as recited in claim 7, wherein the system comprises a handheld electronic device.

9. The system as recited in claim 7, wherein the historical chart comprises a control chart and wherein the ordered arrangement comprises a Pareto chart.

10. A method of identifying inventory control issues, comprising:
obtaining historical inventory data related to product inventory for a product;
displaying a historical chart indicating historical performance over time of the historical inventory data;
identifying an irregularity in the historical performance; and
determining the cause of the irregularity.

11. The method as recited in claim 10, wherein the period of time comprises at least one month.

12. The method as recited in claim 10, wherein the historical chart comprises a control chart.

13. A computerized method for displaying inventory control issues, comprising:
retrieving historical inventory data related to product inventory for a plurality of products, wherein the historical inventory data has been collected periodically over a period of time;
calculating a statistical measure for each product from the historical inventory data collected over the time period for that product; and
displaying the statistical measures for the products in an ordered arrangement according to magnitude.

14. The method as recited in claim 13, wherein the period of time comprises at least one month and wherein the ordered arrangement comprises a Pareto chart.

15. A method of receiving consumer feedback regarding out-of-stock situations, comprising:
offering compensation for reporting out-of-stock situations;
receiving reports of out-of-stock situations; and
conveying compensation for each report received.

16. The method as recited in claim 15, wherein the compensation comprises a product discount.

17. The method as recited in claim 15, wherein the reports are received electronically.

18. The method as recited in claim 15, further comprising:
electronically recording data regarding the out-of-stock situations reported.

19. A method of identifying inventory control issues, comprising:
receiving reports of out-of-stock situations for a variety of products, including non-promotional products;
electronically recording information regarding the reports received;
displaying a summary of the electronic information; and
using the summary to identify potential inventory issues.

20. The method as recited in claim 19, wherein the information comprises at least one of product type, date, time, and cause of situation.

21. A method in a computer system for use in analyzing inventory issues, comprising:
displaying a priority chart illustrating an ordered arrangement of statistical measures for a plurality of products, wherein the statistical measures are related to inventory data for the products;
selecting at least one of the products; and
displaying a historical chart illustrating historical performance relating to the inventory data for the selected product over a period of time.

22. The user method as recited in claim 21, wherein the priority chart and historical chart are displayed at separate times on a computer display.
